(19) United States
(12) Patent Application Publication
(10) Pub. No.: US 2005/0082804 A1
(43) Pub. Date: Apr. 21, 2005

(54) Filterless airbag module

(76) Inventor: Paresh S. Khandhadia, Troy, MI (US)

Correspondence Address: LAURENCE C. BEGIN;L.C. BEGIN & ASSOCIATES, PLLC, PMB 403, 510 HIGHLAND AVE, MILFORD, MI, 48381-1586, US

(21) Appl. No.: 10/966,255

(22) Filed: Oct. 15, 2004

Related U.S. Application Data
(60) Provisional application No. 60/512,049, filed on Oct. 17, 2003.

(51) Int. Cl. B60R 21/26

(52) U.S. Cl. 280/736

(57) ABSTRACT

A filterless airbag module (10) including a structure for cooling combustion gases. The airbag module (10) includes an inflator (12) having a housing (18) and a smokeless gas generating propellant (20) contained within the housing. One or more apertures (24) are formed in the housing (18) to enable fluid communication between an interior of the housing and an exterior of the housing. An airbag (16) is arranged to fluidly communicate with the apertures (24). A combustion gas retainer (42) is positioned exterior of the housing (18) and in alignment with the apertures (24). The retainer (42) and a surface (72) of the housing (18) combine to define a cooling chamber (50) for cooling combustion gases received from the housing (18) via the apertures (24). The cooling chamber (50) is dimensioned to affect an average residence time of combustion gases received in the chamber (50) so that the gases reside in the cooling chamber (50) for a length of time sufficient to cool the gases to a temperature within a predetermined temperature range prior to the gases exiting the cooling chamber (50). A heat-absorbing material may be positioned in the cooling chamber (50) to aid in cooling combustion gases received therein.

### CROSS-REFERENCE TO RELATED APPLICATIONS

This application claims the benefit of provisional application Ser. No. 60/512049 filed on Oct. 17, 2003.

### BACKGROUND OF THE INVENTION

The present invention relates generally to inflators for use in inflatable occupant restraint systems in motor vehicles and, more particularly, to inflators that do not incorporate a filter for removal of particulates from combustion gases and cooling of the gases.

Installation of inflatable occupant restraint systems, generally known as “airbags,” as standard equipment in all new vehicles has intensified the search for smaller, lighter and less expensive restraint systems. Accordingly, since the inflator used in such systems tends to be the heaviest and most expensive component, there is a need for a lighter and less expensive inflator.

A typical inflator includes a cylindrical steel or aluminum housing having a diameter and length related to the vehicle application and characteristics of a gas generant propellant contained therein. Inhalation by a vehicle occupant of particulates generated by propellant combustion during airbag activation can be hazardous. Thus, the inflator is generally provided with an internal, more rarely external, filter comprising one or more layers of steel screen of varying mesh and wire diameter. Gas produced upon combustion of the propellant passes through the filter before exiting the inflator. Particulate material, or slag, produced during combustion of the propellant in a conventional system is substantially removed as the gas passes through the filter. In addition, heat from combustion gases is transferred to the material of the filter as the gases flow through the filter. Thus, as well as filtering particulates from the gases, the filter acts to cool the combustion gases prior to dispersal into the airbag. However, inclusion of the filter in the inflator increases the complexity, weight, and expense of the inflator.

### SUMMARY OF THE INVENTION

Various gas generant formulations have been developed in which the particulates resulting from combustion of the gas generant are substantially eliminated or significantly reduced. To solve the problems of reducing airbag inflator size, weight, cost and efficiency, the present invention obviates the need for a conventional filter by appropriate selection of a smokeless gas generant and by incorporation of combustion gas retainer which cools the combustion gases prior to dispersal of the gases into an airbag. Obviating the need for a filter in an inflator allows the inflator to be simpler, lighter, less expensive and easier to manufacture.

The present invention provides a filterless airbag module comprising an inflator including a housing and a smokeless gas generating propellant contained within the housing. At least one aperture is formed in the housing to enable fluid communication between an interior of the housing and an exterior of the housing. An airbag is arranged to fluidly communicate with the aperture (or apertures). A combustion gas retainer is positioned exterior of the housing and in alignment with the apertures. In one embodiment, the retainer has a base portion extending from the housing, a wall extending from the base portion, and a flange extending from the wall in a direction toward the housing. The retainer and a surface of the housing combine to define a cooling chamber for cooling combustion gases received from the housing via the apertures. A heat-absorbing material may be positioned in the cooling chamber to aid in cooling combustion gases received therein.

In a particular embodiment, the inflator housing is generally cylindrical in shape and has a central axis. The retainer base portion extends radially outwardly from the housing, and the retainer flange extends generally radially inwardly from the wall to form an annular cooling chamber centered on the central axis.

In another aspect of the present invention, a method is provided for cooling combustion gases prior to dispersal of the gases into an inflatable occupant safety device in a vehicle occupant protection system. A housing is provided which defines a combustion chamber and which has at least one aperture formed in the housing to enable fluid communication between the combustion chamber and an exterior of the housing. A combustion gas retainer is positioned exterior of the housing and in alignment with the aperture (or apertures). The retainer and a surface of the housing combine to define a cooling chamber for cooling combustion gases received from the combustion chamber via the apertures. The cooling chamber is dimensioned to affect an average residence time of combustion gases received in the chamber so that the gases reside in the cooling chamber for a length of time sufficient to cool the gases to a temperature within a predetermined temperature range prior to the gases exiting the cooling chamber. Combustion gases are conveyed from the combustion chamber via the apertures to the cooling chamber where the gases are retained for the length of time sufficient to cool the gases to a temperature within the predetermined temperature range.

The retainer has a base portion extending from the housing, a wall extending from the base portion, and a flange extending from the wall in a direction generally toward the housing. The component dimensions of the retainer may be specified so as to affect the average residence time of combustion gases in the cooling chamber.

In one embodiment of the gas cooling method, the retainer base portion, the wall, and the flange are dimensioned to provide the cooling chamber with a predetermined volume in which the gases are retained for cooling to a temperature within the predetermined temperature range. The desired predetermined volume is determined taking into account such factors as the flow rate of the gases into the cooling chamber, the flow rate of the gases out of the cooling chamber, and the temperature of the gases entering the cooling chamber from the combustion chamber.

In another embodiment of the gas cooling method, a combination of the base portion, the wall, and the flange define a flow path for combustion gases through the cooling chamber. The base portion, the wall, and the flange are dimensioned so that the average time required for the gases to travel along the flow path is sufficient to cool the gas to a temperature within the predetermined temperature range prior to exiting the cooling chamber. A heat-absorbing material may be positioned along the flow path so that combustion gases flowing along the flow path impinge upon the heat-absorbing material, further cooling the gases.

In yet another embodiment of the gas cooling method, an end portion of the flange and an exterior surface of the housing are spaced apart to define an exit port for combustion gases from the cooling chamber. The flange is dimensioned to control the size of the exit port to affect a flow rate of the gases from the combustion chamber so that the average residence time of the combustion gas within the cooling chamber is sufficient to cool the gases to a temperature within the predetermined temperature range prior to the gases exiting the cooling chamber.

### BRIEF DESCRIPTION OF THE DRAWINGS

FIG. 1 is an elevational view, partially in section, of an airbag module in accordance with the present invention;

FIG. 2 is an enlarged view taken with the circle 2 of FIG. 1;

FIG. 3 is an enlarged view taken with the circle 2 of FIG. 1 showing a cross-sectional area of the cooling chamber divided into component sub-areas; and

FIG. 4 is a schematic view of a vehicle occupant restraint system incorporating the airbag module of the present invention.

### DETAILED DESCRIPTION

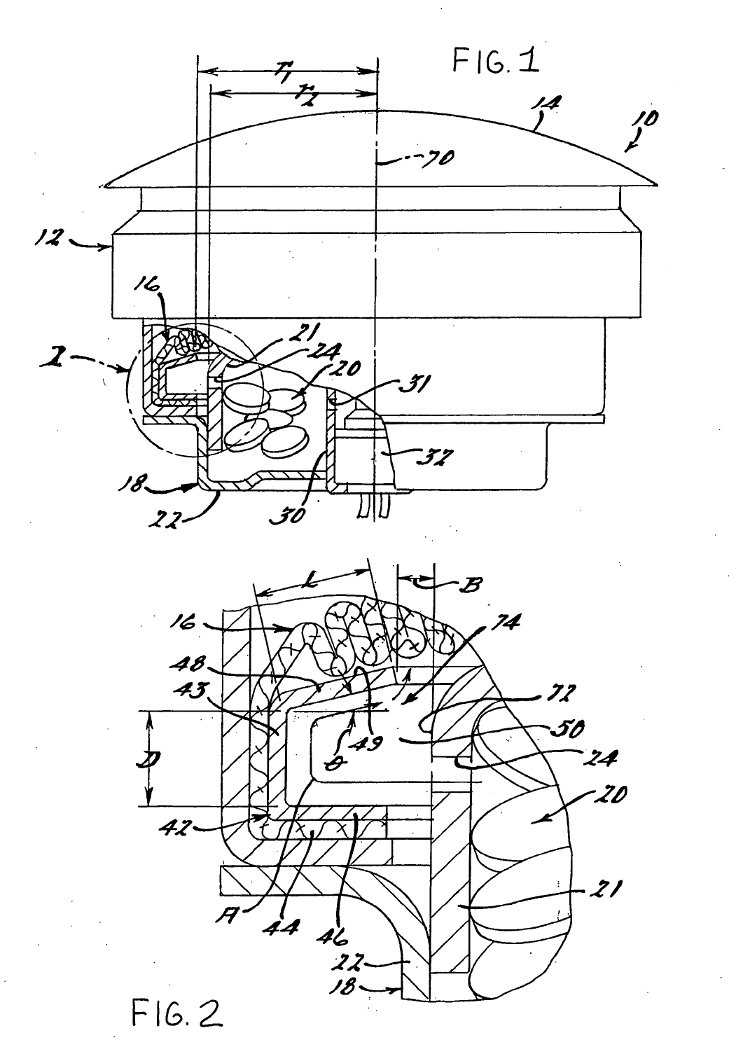

Referring to FIGS. 1 and 2, a driver side airbag module 10 comprises an inflator 12 including an inflator housing 18 having a rupturable frontal closure 14, an airbag 16, and a propellant 20 provided within inflator housing 18. Inflator housing 18 has upper and lower cup-shaped housing sections 21 and 22, respectively, which are welded together in an inverted nested relationship. Upper housing section 21 of housing 18 contains at least one aperture 24 to enable fluid communication between an interior of the housing and an exterior of the housing, thus enabling radial discharge of gas produced by the propellant 20. In the embodiment shown in FIGS. 1 and 2, housing section 21 contains a plurality of apertures 24 spaced about the periphery of the housing section.

Inflator 12 has a perforated and centrally disposed igniter support tube 30 welded therein for the support of an igniter 32. The perforated tube allows a frame front generated by the igniter 32 to pass to the propellant 20, thereby igniting propellant 20 and producing an inflating gas. The propellant 20 may be any known smokeless gas generant composition useful for airbag application and is exemplified by, but not limited to, compositions and processes described in U.S. Pat. Nos. 5,872,329, 6,074,502, 6,287,400, 6,306,232 and 6,475,312 incorporated herein by reference. As used herein, the term “smokeless” should be generally understood to mean such propellants as are capable of combustion yielding at least about 90% gaseous products based on a total product mass; and, as a corollary, less than about 10% solid products based on a total product mass. It has been generally found that filters as used in other inflator designs can be eliminated by using compositions having the described combustion characteristics. Other suitable compositions are set forth in the U.S. patent application Ser. Nos. 10/407,300 and 60/369,775, incorporated herein by reference.

Referring to FIG. 2, in accordance with the present invention, a combustion gas retainer 42 is positioned exterior of housing 18 and in alignment with apertures 24. Retainer 42 has a base portion 46 extending from housing 18, a wall 43 extending from base portion 46, and a flange 48 extending from wall 43 in a direction generally toward the housing. Base portion 46, wall 43, flange 48, and an exterior surface 72 of housing 18 combine to define a cooling chamber, generally designated 50, for cooling combustion gases received from the housing via apertures 24. Wall 43 has a length D and flange 48 has a length L. In addition, wall 43 is spaced a distance 74 from exterior surface 72 of the housing.

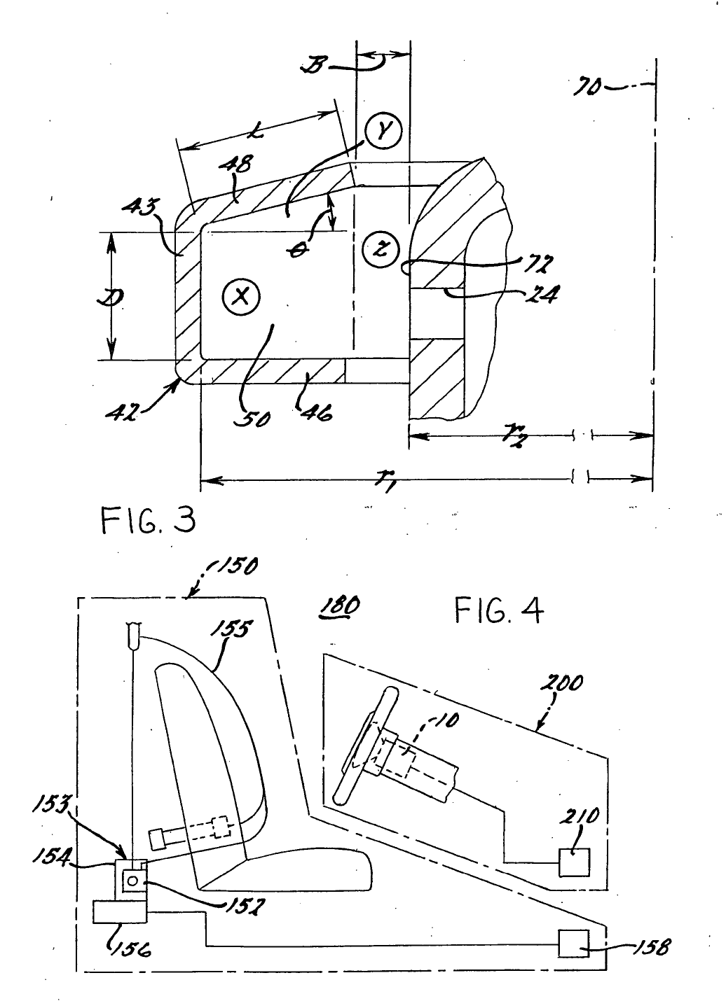

Referring again to FIGS. 1 and 2, in a particular embodiment of the present invention, housing 18 is generally cylindrical in shape and has a central axis 70. Retainer base portion 46 extends radially outwardly from housing 18, and retainer flange 48 extends generally radially inwardly from wall 43. In this embodiment, base portion 46, wall 43, flange 48, and an exterior surface 72 of housing 18 form an annular cooling chamber 50 centered on central axis 70. Referring to FIG. 3, the volume of this annular cooling chamber may be approximated by calculating the annular volume generated by rotating the cross-sectional area of the cooling chamber 360° about axis 70. To simplify the calculations, the cross-sectional area of cooling chamber 50 is divided into three component areas, designated X, Y, and Z in FIG. 3. In the following equations, D is the length of wall 43, r₁ is the distance from central axis 70 to wall 43, r₂ is the radius of exterior surface 72 of housing 18, θ is the angle between flange 48 and a plane extending generally perpendicular to central axis 70, and L is the length of flange 48.

The mathematical formula for the volume of a solid circular cylinder is calculated using the relation:
JIr²h (1)
where r is the radius of the cylinder and h is the length of the cylinder. Similarly, the volume of an annular space residing between two concentric cylinders may be calculated by computing the volume of each cylinder using equation (1), then subtracting the volume of the inner cylinder from the volume of the outer cylinder. For example, in calculating the annular volume formed by rotating the area X about axis 70, the volume of the outer cylinder is given by the relation JIDr₁², and the volume of the inner cylinder is given by the relation JID(r₁−L cos θ)². Thus, the annular volume formed by rotating the area X about axis 70 is given by the relation:
JIDr₁²−JID(r₁−L cos θ)² (2)
Similarly, the annular volume formed by rotating area Y about axis 70 is given by the relation:
½(JI(D+L sin θ)r₁²−JI(D+L sin θ)(r₁−L cos θ)² (3)
Also, the annular volume formed by rotating area Z about axis 70 is given by the relation:
JI(D+L sin θ)(r₁−L cos θ)²−JI(D+L sin θ)r₂² (4)

In view of the above, the total annular volume is approximated by the sum of the computed component volumes obtained by rotating cross-sectional areas X, Y, and Z about axis 70. Thus, the cooling chamber volume is approximated by adding the component volumes obtained using equations (2), (3) and (4). As an example, for L=2 inches, r₁=10 inches, r₂=7 inches, D=2 inches, and θ=30°, the addition of component volumes obtained using equations (2), (3), and (4) yields a total cooling chamber volume of approximately 530 in.³.

Combustion gases exiting inflator housing 18 are volumetrically expanded and cooled in cooling chamber 50, prior to entering airbag 16. As illustrated by arrow A in FIG. 2, the flange 48 on the gas retainer 42 redirects radial flow of the gas from the inflator 12 to generally axial flow into the airbag 16.

Also in accordance with the present invention, a method is contemplated for cooling combustion gases received from the inflator housing prior to dispersal of the gases into an inflatable device of a vehicle occupant protection system. It is believed that the dimensions of cooling chamber 50 may be controlled to affect the average residence time of combustion gases in the cooling chamber. This is done to ensure that the gases reside in the cooling chamber for a length of time sufficient to cool the gases to a temperature within a predetermined temperature range prior to the gases exiting cooling chamber 50. The appropriate dimensions of the cooling chamber are selected taking into account such factors as the flow rate of the combustion gases from the combustion chamber into the cooling chamber, the desired flow rate of gases out of the cooling chamber (determined by such factors as the desired airbag inflation profile), and the temperature of the gases entering the cooling chamber from the combustion chamber.

Referring to FIG. 2, in one embodiment of the gas cooling method, retainer base portion 46, wall 43, and flange 48 are dimensioned to define a cooling chamber 50 having a predetermined volume in which the gases are retained for cooling. It is believed that, given substantially fixed flow rates of gas into and out of cooling chamber 50, increasing the volume of cooling chamber 50 will increase the average residence time of a mole of gas within the cooling chamber, enabling the gases to be cooled to a temperature within the desired temperature range. Thus, cooling of the combustion gases may be enhanced by increasing the volume of the cooling chamber, and the degree of cooling may be controlled by controlling the volume of the cooling chamber.

Referring again to FIG. 2, in another embodiment of the gas cooling method, retainer base portion 46, wall 43, and flange 48 define a flow path, generally designated A, for combustion gases flowing from housing 18 through cooling chamber 50. In this embodiment, the average residence time of the combustion gases in cooling chamber 50 is affected by specifying a length of flow path A such that the average time required for combustion gases to travel along the flow path from the housing to an exit port 74 of the cooling chamber is sufficient to cool the gases to a temperature within the desired predetermined temperature range of the gases prior to exiting the cooling chamber. In the embodiment shown in FIG. 2, the length of flow path A may be approximated by the relation B+D+L, where B is the distance between exterior surface 72 of housing 18 and wall 43. Thus, one or more of the dimensions B, D, and L may be specified to provide the desired flow path length. Cooling of the combustion gases may be enhanced by positioning a heat-absorbing material (not shown) along flow path A. Then, combustion gases flowing along path A impinge upon the heat-absorbing material, to aid in cooling the gases.

In yet another embodiment of the gas cooling method, an end portion 49 of flange 48 is dimensioned so as to be spaced apart from exterior surface 72 of housing 18 to define an exit port 74 for combustion gases from cooling chamber 50. Length L of flange 48 is dimensioned to control the size of exit port 74 to affect a flow rate of the gases from cooling chamber 50, thereby affecting the average residence time of the combustion gas within cooling chamber 50. By suitably constricting exit port 74, the combustion gases may be retained in cooling chamber 50 for a time sufficient to cool the gases to a temperature within the desired temperature range prior to the gases exiting cooling chamber 50.

In any of the methods described above for affecting the average residence time of the combustion gases in cooling chamber 50, cooling of the gases may be enhanced by positioning a heat-absorbing material (not shown) in the cooling chamber. One example of such material is a carbon compound formed into, for example, a grating that acts as a heat sink.

Referring to FIG. 4, airbag module 10 may be incorporated into a broader, more comprehensive vehicle occupant restraint system 180 including additional elements such as a safety belt assembly 150. FIG. 4 shows a schematic diagram of one exemplary embodiment of such a restraint system. Safety belt assembly 150 includes a safety belt housing 152 and a safety belt 155 in accordance with the present invention extending from housing 152. A safety belt retractor mechanism 154 (for example, a spring-loaded mechanism) may be coupled to an end portion 153 of the belt. In addition, a safety belt pretensioner 156 may be coupled to belt retractor mechanism 154 to actuate the retractor mechanism in the event of a collision. Typical seat belt retractor mechanisms which may be used in conjunction with the safety belt embodiments of the present invention are described in U.S. Pat. Nos. 5,743,480, 5,553,803, 5,667,161, 5,451,008, 4,558,832 and 4,597,546, incorporated herein by reference. Illustrative examples of typical pretensioners with which the safety belt embodiments of the present invention may be combined are described in U.S. Pat. Nos. 6,505,790 and 6,419,177, incorporated herein by reference.

Safety belt assembly 150 may be in communication with a crash event sensor 158 (for example, an inertia sensor or an accelerometer) including a known crash sensor algorithm that signals actuation of belt pretensioner 156 via, for example, activation of a pyrotechnic igniter (not shown) incorporated into the pretensioner. U.S. Pat. Nos. 6,505,790 and 6,419,177, previously incorporated herein by reference, provide illustrative examples of pretensioners actuated in such a manner. Airbag module 10 may also be in communication with a crash event sensor 210 including a known crash sensor algorithm that signals actuation of airbag module 10 via, for example, activation of airbag inflator 12 in the event of a collision.

It will be understood that the foregoing descriptions of various embodiments of the present invention is for illustrative purposes only. As such, the various structural and operational features herein disclosed are susceptible to a number of modifications, none of which departs from the scope of the present invention as defined in the appended claims.

1. A filterless airbag module comprising:
an inflator including a housing;
a gas generating propellant contained within the housing;
at least one aperture formed in the housing to enable fluid communication between an interior of the housing and an exterior of the housing;
a combustion gas retainer positioned exterior of the housing and in alignment with the at least one aperture, the retainer and a surface of the housing defining a cooling chamber for cooling combustion gases received from the housing via the at least one aperture; and
an airbag arranged to fluidly communicate with the at least one aperture.

2. The airbag module of claim 1 wherein the housing comprises an upper section and a lower section, and wherein the at least one aperture is formed in the housing upper section.

3. The airbag module of claim 1 wherein the retainer has a base portion extending from the housing, a wall extending from the base portion, and a flange extending from the wall in a direction generally toward the housing, and wherein the cooling chamber is defined by the base portion, the wall, the flange, and an exterior surface of the housing.

4. The airbag module of claim 3 wherein the wall and the flange each have a predetermined length, the housing is generally cylindrical in shape and has a central axis, the retainer base portion extends radially outwardly from the housing, and the retainer flange extends generally radially inwardly from the wall, the base portion, the wall, the flange, and the exterior surface of the housing thereby forming an annular cooling chamber centered on the central axis.

5. The airbag module of claim 4, wherein the volume of the annular cooling chamber is approximated by the relation:
JIDr₁²−JID(r₁−L cos θ)²+½(JI(D+L sin θ)r₁²−JI(D+L sin θ)(r₁−L cos θ)²+JI(D+L sin θ)(r₁−L cos θ)²−JI(D+L sin θ)r₂²
where
D=the length of the wall;
r₁=the distance from the central axis to the wall;
r₂=the radius of the exterior surface of the housing;
θ=the angle between the flange and a plane extending generally perpendicular to the central axis; and
L=the length of the flange.

6. The airbag module of claim 1 further comprising a heat-absorbing material positioned in the cooling chamber for cooling combustion gases received therein.

7. The airbag module of claim 1 wherein the smokeless gas generating propellant comprises a mixture of high-nitrogen nonazide fuel selected from the class consisting of 1-, 3-, and 5-substituted amine salts of triazoles, and, 1- and 5-substituted amine salts of tetrazoles; and dry-mixed with an oxidizer selected from the group consisting of phase stabilized ammonium nitrate.

8. The airbag module of claim 1 wherein the gas generating propellant comprises a mixture of:
a high-nitrogen nonazide fuel selected from the class consisting of 1-, 3-, 5-substituted amine salts of triazoles and 1- and 5-substituted amine salts of tetrazoles, the fuel employed in a concentration of 15 to 65% by weight of the gas generant composition; and
an oxidizer consisting of phase stabilized ammonium nitrate, the oxidizer employed in a concentration of 35 to 85% by weight of the gas generant composition, wherein the fuel is selected from the group consisting of monoguanidinium salt of 5,5′-Bis-1H-tetrazole, diguanidinium salt of 5,5′-Bis-1H-tetrazole, monoaminoguanidinium salt of 5,5′-Bis-1H-tetrazole, diaminoguanidinium salt of 5,5′-Bis-1H-tetrazole, monohydrazinium salt of 5,5′-Bis-1H-tetrazole, dihydrazinium salt of 5,5′-Bis-1H-tetrazole, monoammonium salt of 5,5′-bis-H-tetrazole, diammonium salt of 5,5′-bis-1H-tetrazole, mono-3-amino-1,2,4-triazolium salt of 5,5′-bis-1H-tetrazole, di-3-amino-1,2,4-triazolium salt of 5,5′-bis-1H-tetrazole, diguanidinium salt of 5,5′-Azobis-1H-tetrazole, and monoammonium salt of 5-Nitramino-1H-tetrazole.

9. The airbag module of claim 1 wherein the gas generating propellant comprises a mixture of:
a high-nitrogen nonazide fuel selected from the class consisting of 1-, 3-, and 5-substituted amine salts of triazoles, and, 1- and 5-substituted amine salts of tetrazoles;
a second fuel selected from the group consisting of hydrazodicarbonamide and azodicarbonamide; and
phase stabilized ammonium nitrate.

10. The airbag module of claim 1 wherein the gas generating propellant comprises a mixture of:
a high-nitrogen nonazide fuel selected from the class consisting of 1-, 3-, 5-substituted amine salts of triazoles and 1- and 5-substituted amine salts of tetrazoles, the fuel employed in a concentration of 5 to 45% by weight of the gas generant composition;
a second fuel selected from the group consisting of hydrazodicarbonamide and azodicarbonamide, the second fuel employed in a concentration of 1 to 35% by weight of the gas generant composition; and
an oxidizer consisting of phase stabilized ammonium nitrate, the oxidizer employed in a concentration of 55 to 85% by weight of the gas generant composition, wherein the fuel is selected from the group consisting of monoguanidinium salt of 5,5′-Bis-1H-tetrazole, diguanidinium salt of 5,5′-Bis-1H-tetrazole, monoaminoguanidinium salt of 5,5′-Bis-1H-tetrazole, diaminoguanidinium salt of 5,5′-Bis-1H-tetrazole, monohydrazinium salt of 5,5′-Bis-1H-tetrazole, dihydrazinium salt of 5,5′-Bis-1H-tetrazole, monoammonium salt of 5,5′-bis-1H-tetrazole, diammonium salt of 5,5′-bis-1H-tetrazole, mono-3-amino-1,2,4-triazolium salt of 5,5′-bis-1H-tetrazole, di-3-amino-1,2,4-triazolium salt of 5,5′-bis-1H-tetrazole, diguanidinium salt of 5,5′-Azobis-1H-tetrazole, and monoammonium salt of 5-Nitramino-1H-tetrazole.

11. The airbag module of claim 1 wherein the gas generating propellant comprises a mixture of:
a high-nitrogen nonazide fuel selected from the group consisting of tetrazoles, triazoles, salts of tetrazoles, and salts of triazoles;
a second fuel selected from the group consisting of hydrazodicarbonamide and azodicarbonamide; and
phase stabilized ammonium nitrate employed in a concentration of 55-85% by weight of the gas generant composition.

12. The airbag module of claim 1 wherein the gas generating propellant comprises a mixture of:
a fuel consisting of 5-aminotetrazole nitrate; and
at least one oxidizer selected from the group consisting of phase stabilized ammonium nitrate; alkali metal and alkaline earth metal nitrates, nitrites, perchlorates, chlorates, and chlorites; and, alkali, alkaline earth, and transitional metal oxides, wherein the 5-aminotetrazole nitrate is employed in a concentration of 55 to 85% by weight of the gas generant composition, and the oxidizer is employed in a concentration of 20 to 45% by weight of the gas generant.

13. The airbag module of claim 1 wherein the gas generating propellant comprises a mixture of a fuel consisting of 5-aminotetrazole nitrate; and
phase stabilized ammonium nitrate, wherein 5-aminotetrazole nitrate is employed in a concentration of 30 to 95% by weight of the gas generant composition, and phase stabilized ammonium nitrate is employed in a concentration of 5 to 70% by weight of the gas generant composition.

14. The airbag module of claim 1 wherein the gas generating propellant comprises a composition wherein 5-aminotetrazole nitrate is employed in a concentration of about 73% by weight of the gas generant composition, and phase stabilized ammonium nitrate is employed in a concentration of about 27% by weight of the gas generant composition.

15. The airbag module of claim 1 wherein the gas generating propellant consists essentially of a mixture of:
a fuel consisting of 5-aminotetrazole nitrate; and
phase stabilized ammonium nitrate, wherein 5-aminotetrazole nitrate is employed in a concentration of 30 to 95% by weight of the gas generant composition, and phase stabilized ammonium nitrate is employed in a concentration of 5 to 70% by weight of the gas generant composition.

16. The airbag module of claim 1 wherein the gas generating propellant consists of a mixture of:
a fuel consisting of 5-aminotetrazole nitrate; and
phase stabilized ammonium nitrate, wherein 5-aminotetrazole nitrate is employed in a concentration of 30 to 95% by weight of the gas generant composition, and phase stabilized ammonium nitrate is employed in a concentration of 5 to 70% by weight of the gas generant composition.

17. The airbag module of claim 1 wherein the gas generating propellant consists of a hydrated or anhydrous mixture of:
nitroguanidine and at least one nonazide high-nitrogen fuel selected from the group consisting of guanidines, tetrazoles, triazoles, salts of tetrazoles, and salts of triazoles; and
phase stabilized ammonium nitrate as an oxidizer, wherein the composition has a melting point of at least 115.degree. C., the ammonium nitrate is phase stabilized by coprecipitating with potassium nitrate, the nitroguanidine comprises 1%-26% by weight of the mixture; the at least one nonazide high-nitrogen fuel comprises 4%-40% by weight of the mixture, the nitroguanidine in combination with the at least one nonazide high nitrogen fuel comprises 15%-60% by weight of the mixture, and, the phase stabilized ammonium nitrate comprises 40%-85% by weight of the mixture.

18. The airbag module of claim 1 wherein the gas generating propellant consists of a hydrated or anhydrous mixture of:
nitroguanidine and at least one nonazide high-nitrogen fuel selected from the group consisting of monoguanidinium salt of 5,5′-Bis-1H-tetrazole, diguanidinium salt of 5,5′-Bis-1H-tetrazole, monoaminoguanidinium salt of 5,5′-Bis-1H-tetrazole, diaminoguanidinium salt of 5,5′-Bis-1H-tetrazole, monohydrazinium salt of 5,5′-Bis-1H-tetrazole, dihydrazinium salt of 5,5′-Bis-1H-tetrazole, monoammonium salt of 5,5′-bis-1H-tetrazole, diammonium salt of 5,5′-bis-1H-tetrazole, mono-3-amino-1,2,4-triazolium salt of 5,5′-bis-1H-tetrazole, di-3-amino-1,2,4-triazolium salt of 5,5′-bis-1H-tetrazole, diguanidinium-5,5′-azotetrazolate, monoammonium salt of 3-nitro-1,2,4-triazole, monoguanidinium salt of 3-nitro-1,2,4-triazole, diammonium salt of dinitrobitriazole, diguanidinium salt of dinitrobitriazole, and monoammonium salt of 3,5-dinitro-1,2,4-triazole; and
phase stabilized ammonium nitrate as an oxidizer, wherein the ammonium nitrate is phase stabilized by coprecipitating with potassium nitrate, the nitroguanidine comprises 1%-26% by weight of the mixture, the at least one nonazide high-nitrogen fuel comprises 4%-40% by weight of the mixture, the nitroguanidine in combination with the at least one nonazide high nitrogen fuel comprises 15%-60% by weight of the mixture, and, the phase stabilized ammonium nitrate comprises 40%-85% by weight of the mixture.

19. The airbag module of claim 1 wherein the gas generating propellant consists of a hydrated or anhydrous mixture of:
nitroguanidine and at least one nonazide high-nitrogen fuel selected from the group consisting of nonmetal salts of triazoles substituted at the 1-, 3-, and 5-positions, and nonmetal salts of tetrazoles substituted at the 1- and 5-positions, the salts substituted at each position with a nitrogen-containing group; and
phase stabilized ammonium nitrate as an oxidizer, wherein the ammonium nitrate is phase stabilized by coprecipitating with potassium nitrate, the nitroguanidine comprises 1%-26% by weight of the mixtures the at least one nonazide high-nitrogen fuel comprises 4%-40% by weight of the mixture, the nitroguanidine in combination with the at least one nonazide high nitrogen fuel comprises 15%-60% by weight of the mixture, and, the phase stabilized ammonium nitrate comprises 40-85% by weight of the mixture.

20. The airbag module of claim 1 wherein the gas generating propellant consists of a hydrated or anhydrous mixture of:
nitroguanidine and at least one nonazide high-nitrogen fuel selected from the group consisting of 1-, 3-, 5-substituted nonmetal salts of triazoles, and 1-, 5-substituted nonmetal salts of tetrazoles, the salts substituted at each position with a nitrogen-containing compound; and
phase stabilized ammonium nitrate as an oxidizer, wherein the ammonium nitrate is phase stabilized by coprecipitating with potassium nitrate, the nitroguanidine comprises 1%-26% by weight of the mixture; the at least one nonazide high-nitrogen fuel comprises 4%-40% by weight of the mixture, the nitroguanidine in combination with the at least one nonazide high nitrogen fuel comprises 15%-60% by weight of the mixture, the phase stabilized ammonium nitrate comprises 40-85% by weight of the mixture.

21. The airbag module of claim 1 wherein the gas generating propellant consists of a hydrated or anhydrous mixture of:
nitroguanidine and at least one nonazide high-nitrogen fuel selected from the group consisting of guanidines, tetrazoles, triazoles, salts of tetrazoles, and salts of triazoles;
phase stabilized ammonium nitrate as an oxidizer, a burn rate modifier selected from the group consisting of alkali, alkaline earth, and transitional metal salts of tetrazole and triazole, triaminoguanidine nitrate, dicyandiamide, alkali and alkaline earth metal salts of dicyandiamide; alkali and alkaline earth borohydrides, and mixtures thereof; and
a coolant selected from the group consisting of clay, silica, glass, and alumina, and mixtures thereof;
wherein the composition has a melting point of at least 115° C., the ammonium nitrate is phase stabilized by coprecipitating with potassium nitrate, the nitroguanidine comprises 1%-26% by weight of the mixture; the at least one nonazide high-nitrogen fuel comprises 4%-40% by weight of the mixture, the nitroguanidine in combination with the at least one nonazide high nitrogen fuel comprises 15%-60% by weight of the mixture, the phase stabilized ammonium nitrate comprises 40-85% by weight of the mixture, the burn rate modifier comprises 0-10% by weight of the mixture, and the coolant comprises 0-10% by weight of the mixture.

22. The airbag module of claim 1 wherein the gas generating propellant consists of a hydrated or anhydrous mixture of:
nitroguanidine and at least one nonazide high-nitrogen fuel selected from the group consisting of monoguanidinium salt of 5,5′-Bis-1H-tetrazole, diguanidinium salt of 5,5′-Bis-1-tetrazole, monoaminoguanidinium salt of 5,5′-Bis-1H-tetrazole, diaminoguanidinium salt of 5,5′-Bis-1H-tetrazole, monohydrazinium salt of 5,5′-Bis-1H-tetrazole, dihydrazinium salt of 5,5′-Bis-1-tetrazole, monoammonium salt of 5,5′-bis-1H-tetrazole, diammonium salt of 5,5′-bis-1H-tetrazole, mono-3-amino-1,2,4-triazolium salt of 5,5′-bis-1H-tetrazole, di-3-amino-1,2,4-triazolium salt of 5,5′-bis-1H-tetrazole, diguanidinium-5,5′-azotetrazolate, monoammonium salt of 3-nitro-1,2,4-triazole, monoguanidinium salt of 3-nitro-1,2,4-triazole, diammonium salt of dinitrobitriazole, diguanidinium salt of dinitrobitriazole, and monoammonium salt of 3,5-dinitro-1,2,4-triazole;
phase stabilized ammonium nitrate as an oxidizer,
a burn rate modifier selected from the group consisting of alkali, alkaline earth, and transitional metal salts of tetrazole and triazole, triaminoguanidine nitrate, dicyandiamide, alkali and alkaline earth metal salts of dicyandiamide; alkali and alkaline earth borohydrides, and mixtures thereof; and
a coolant selected from the group consisting of clay, silica, glass, and alumina, and mixtures thereof;
wherein the ammonium nitrate is phase stabilized by coprecipitating with potassium nitrate, the nitroguanidine comprises 1%-26% by weight of the mixture, the at least one nonazide high-nitrogen fuel comprises 4%-40% by weight of the mixture, the nitroguanidine in combination with the at least one nonazide high nitrogen fuel comprises 15%-60% by weight of the mixture, the phase stabilized ammonium nitrate comprises 40%-85% by weight of the mixture, the burn rate modifier comprises 0-10% by weight of the mixture, and the coolant comprises 0-10% by weight of the mixture.

23. The airbag module of claim 1 wherein the gas generating propellant consists of a hydrated or anhydrous mixture of: nitroguanidine and at least one nonazide high-nitrogen fuel selected from the group consisting of nonmetal salts of triazoles substituted at the 1-, 3-, and 5-positions, and nonmetal salts of tetrazoles substituted at the 1- and 5-positions, the salts substituted at each position with a nitrogen-containing group;
phase stabilized ammonium nitrate as an oxidizer,
a burn rate modifier selected from the group consisting of alkali, alkaline earth, and transitional metal salts of tetrazole and triazole, triaminoguanidine nitrate, dicyandiamide, alkali and alkaline earth metal salts of dicyandiamide; alkali and alkaline earth borohydrides, and mixtures thereof; and
a coolant selected from the group consisting of clay, silica, glass, and alumina, and mixtures thereof;
wherein the ammonium nitrate is phase stabilized by coprecipitating with potassium nitrate, the nitroguanidine comprises 1%-26% by weight of the mixture, the at least one nonazide high-nitrogen fuel comprises 4%-40% by weight of the mixture, the nitroguanidine in combination with the at least one nonazide high nitrogen fuel comprises 15%-60% by weight of the mixture, the phase stabilized ammonium nitrate comprises 40-85% by weight of the mixture, the burn rate modifier comprises 0-10% by weight of the mixture, and the coolant comprises 0-10% by weight of the mixture.

24. The airbag module of claim 1 wherein the gas generating propellant consists of a hydrated or anhydrous mixture of:
nitroguanidine and at least one nonazide high-nitrogen fuel selected from the group consisting of 1-, 3-, 5-substituted nonmetal salts of triazoles, and 1-, 5-substituted nonmetal salts of tetrazoles, the salts substituted at each position with a nitrogen-containing compound;
phase stabilized ammonium nitrate as an oxidizer,
a burn rate modifier selected from the group consisting of alkali, alkaline earth, and transitional metal salts of tetrazole and triazole, triaminoguanidine nitrate, dicyandiamide, alkali and alkaline earth metal salts of dicyandiamide; alkali and alkaline earth borohydrides, and mixtures thereof; and
a coolant selected from the group consisting of clay, silica, glass, and alumina, and mixtures thereof;
wherein the ammonium nitrate is phase stabilized by coprecipitating with potassium nitrate, the nitroguanidine comprises 1%-26% by weight of the mixture; the at least one nonazide high-nitrogen fuel comprises 4%-40% by weight of the mixture, the nitroguanidine in combination with the at least one nonazide high nitrogen fuel comprises 15%-60% by weight of the mixture, the phase stabilized ammonium nitrate comprises 40-85% by weight of the mixture, the burn rate modifier comprises 0-10% by weight of the mixture, and the coolant comprises 0-10% by weight of the mixture.

25. The airbag module of claim 1 wherein the gas generating propellant consists of a hydrated or anhydrous mixture of:
nitroguanidine,
diammonium salt of 5,5′-bis-1H-tetrazole,
phase stabilized ammonium nitrate as an oxidizer,
wherein the ammonium nitrate is phase stabilized by coprecipitating with potassium nitrate, the nitroguanidine comprises 1%-26% by weight of the mixtures the diammonium salt of 5,5′-bis-1H-tetrazole comprises 4%40% by weight of the mixture, the nitroguanidine in combination with the diammonium salt of 5,5′-bis-1H-tetrazole comprises 15%-60% by weight of the mixture, and, the phase stabilized ammonium nitrate comprises 40-85% by weight of the mixture.

26. A method for cooling combustion gases comprising the steps of:
providing a housing defining a combustion chamber and having at least one aperture formed in the housing to enable fluid communication between the combustion chamber and an exterior of the housing;
providing a combustion gas retainer positioned exterior of the housing and in alignment with the at least one aperture, the retainer and a surface of the housing defining a cooling chamber for cooling combustion gases received from the combustion chamber via the at least one aperture, the cooling chamber being dimensioned to affect an average residence time of combustion gases received therein so that the gases reside in the cooling chamber for a length of time sufficient to cool the gases to a temperature within a predetermined temperature range prior to the gases exiting the cooling chamber;
conveying combustion gases from the combustion chamber to the cooling chamber via the at least one aperture; and
retaining the gases within the cooling chamber for the length of time sufficient to cool the gases to a temperature within the predetermined temperature range.

27. The method of claim 26 wherein the step of providing a retainer comprises the steps of providing a base portion extending from the housing, providing a wall extending from the base portion, and providing a flange extending from the wall in a direction generally toward the housing to define, in combination with an exterior surface of the housing, a cooling chamber.

28. The method of claim 27 wherein the steps of providing a base portion, a wall, and a flange further comprise the step of dimensioning the base portion, the wall, and the flange to provide a cooling chamber having a predetermined volume configured to retain the combustion gases therein for a time sufficient to cool the gases to a temperature within the predetermined temperature range prior to the gases exiting the cooling chamber.

29. The method of claim 27 wherein a combination of the base portion, the wall, and the flange define a flow path for combustion gases through the cooling chamber, and wherein the step of providing a base portion, a wall, and a flange further comprises the step of dimensioning the base portion, the wall, and the flange so that an average time required for the gases to travel along the flow path is sufficient to cool the gas to a temperature within the predetermined temperature range prior to the gases exiting the cooling chamber.

30. The method of claim 30 wherein the flow path of the combustion gases extends between the combustion chamber and an inflatable device of a vehicle occupant protection system, and wherein the gases are cooled to a temperature within the predetermined temperature range prior to dispersal of the gases from the cooling chamber into the inflatable device.

31. The method of claim 31 further comprising the step of positioning a heat-absorbing material along the flow path whereby combustion gases received in the cooling chamber flow along the flow path defined by the retainer and impinge upon the heat-absorbing material to aid in cooling of the gases prior to direction of the gases into the inflatable device.

32. The method of claim 27 wherein an end portion of the flange and an exterior surface of the housing are spaced apart to define an exit port for combustion gases from the cooling chamber, and wherein the flange is dimensioned to control the size of the exit port to affect a flow rate of the gases from the combustion chamber so that the average residence time of the combustion gas within the cooling chamber is sufficient to cool the gases to a temperature within the predetermined temperature range prior to the gases exiting the cooling chamber.

33. The method of claim 27 further comprising the step of positioning heat-absorbing material in the cooling chamber for cooling combustion gases received therein.

34. A filterless airbag inflator comprising:
a housing including an upper section and a lower section;
a smokeless gas generating propellant contained within the housing;
at least one aperture formed in the housing upper section to enable fluid communication between an interior of the housing and an exterior of the housing; and
a combustion gas retainer positioned exterior of the housing and in alignment with the at least one aperture, the retainer having a base portion extending from the housing, a wall extending from the base portion, and a flange extending from the wall in a direction generally toward the housing, the base portion, the wall, the flange, and an exterior surface of the housing defining a cooling chamber for retaining combustion gases received from the housing for a length of time sufficiently to cool the gases to a temperature within the predetermined temperature range.

35. A vehicle occupant restraint system comprising:
a filterless airbag module including an inflator having an inflator a housing, a gas generating propellant contained within the housing, at least one aperture formed in the housing to enable fluid communication between an interior of the housing and an exterior of the housing, a combustion gas retainer positioned exterior of the housing and in alignment with the at least one aperture, the retainer and a surface of the housing defining a cooling chamber for cooling combustion gases received from the housing via the at least one aperture, and an airbag arranged to fluidly communicate with the at least one aperture; and
a safety belt assembly including a housing and a safety belt extending from the housing, the safety belt having a first panel, a second panel affixed to the first panel to form a pocket therebetween, and an amount of an energy-absorbing material secured in the pocket.

36. The vehicle occupant restraint system of claim 35 wherein the safety belt assembly further comprises:
a belt retractor mechanism coupled to an end portion of the safety-belt; and
a safety belt pretensioner coupled to the belt retractor mechanism to actuate the retractor in the event of a collision.

37. The vehicle occupant restraint system of claim 36 wherein the vehicle occupant restraint system is in communication with a crash event sensor including a crash sensor algorithm that signals actuation of the belt pretensioner in the event of a collision.

38. The vehicle occupant restraint system of claim 36 wherein the airbag module is in communication with a crash event sensor including a crash sensor algorithm that signals actuation of the airbag system in the event of a collision.

39. The airbag module of claim 35 wherein the gas retainer has a base portion extending from the housing, a wall extending from the base portion, and a flange extending from the wall in a direction generally toward the housing, and wherein the cooling chamber is defined by the base portion, the wall, the flange, and an exterior surface of the housing.
